(19) United States
(12) Patent Application Publication
(10) Pub. No.: US 2013/0222209 A1
(43) Pub. Date: Aug. 29, 2013

(54) DISPLAY CONTROL APPARATUS AND DISPLAY CONTROL METHOD

(71) Applicant: KABUSHIKI KAISHA TOSHIBA, (US)

(72) Inventor: Gen Watanabe, Akishima-shi (JP)

(73) Assignee: KABUSHIKI KAISHA TOSHIBA, Tokyo (JP)

(21) Appl. No.: 13/777,354

(22) Filed: Feb. 26, 2013

(30) Foreign Application Priority Data
Feb. 29, 2012 (JP) 2012-044799

(51) Int. Cl. G09G 5/00

(52) U.S. Cl. CPC G09G 5/00
USPC 345/1.3

(57) ABSTRACT

According to one embodiment, a display control apparatus includes a communication module, a detector and a display. The communication module is configured to communicate with an external display control apparatus. The detector is configured to detect a positional relationship of the external display control apparatus with respect to the display control apparatus. The display controller is configured to control a setting of extended display for a display screen of the external display control apparatus, based on the detected positional relationship.

### CROSS REFERENCE TO RELATED APPLICATION(S)

The present disclosure claims priority to Japanese Patent Application No. 2012-044799, filed on Feb. 29, 2012, which is incorporated herein by reference in its entirety.

### FIELD

Embodiments described herein relate generally to a display control apparatus which, so to speak, automatic recognizes a display position when connected to an external display device, and a display control method

### BACKGROUND

Recently, users are increasing who use a function called “multi-display” in which a plurality of display devices are connected to an information processing apparatus such as a PC (Personal Computer) and the plurality of display devices operate (display things) as if they constitute a single display device. When the multi-display function is used, the user can perform various works with using a large display area which is hardly obtained by a single display device. Therefore, for example, there is a possibility that an effect of improving the working efficiency is achieved.

In this circumstance, techniques for realizing a multi-display is being developed. An example of the techniques is that a multi-display is realized by providing a notebook PC with a mechanism for enabling a display device to be detachably attached to the PC. In this case, however, it is necessary to consider a positional relationship between the main screen and an external display device.

### BRIEF DESCRIPTION OF THE DRAWINGS

FIG. 1 is an exemplary block diagram showing an apparatus (notebook PC) according to a second embodiment;

FIG. 2 is an exemplary block diagram showing another apparatus (external display device) according to the second embodiment;

FIGS. 3A to 3C exemplary flowcharts showing a setting process (for the notebook PC) when an external display device(s) are connected to the notebook PC, according to the second embodiment;

FIGS. 4A to 4C is an exemplary flowchart showing a setting process (for an external display device(s)) when the external display device(s) are connected to the notebook PC, according to the second embodiment;

FIG. 5 is an exemplary view showing a setting value table (1) of an external display device (notebook PC-external display device), according to the second embodiment;

FIG. 6 is an exemplary view showing a setting value table (2) of external display devices (external display device A-external display device B), according to the second embodiment;

FIG. 7 is an exemplary view showing a structural example of an infrared pulse packet which is used in the second embodiment; and

FIG. 8 is an exemplary diagram showing an example of a connection among the notebook PC and two external display devices according to the second embodiment.

### DETAILED DESCRIPTION

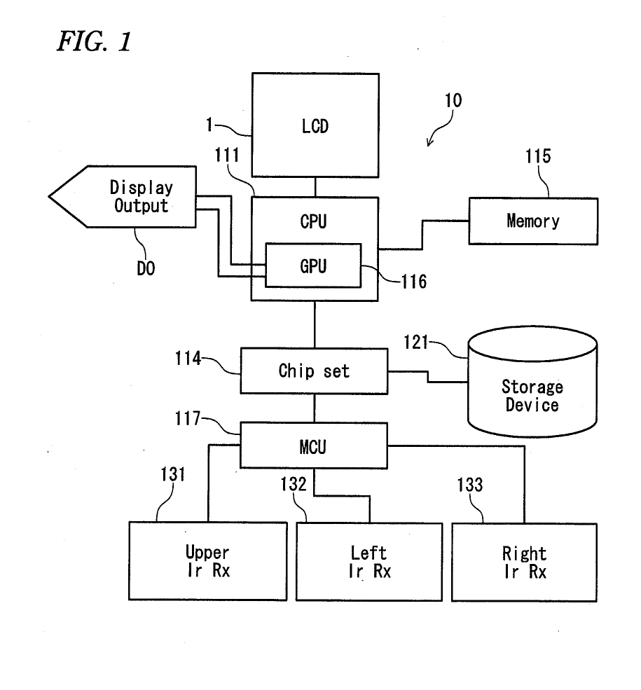

Hereinafter, various embodiments of the invention will be described in detail with reference to FIGS. 1 to 8.

According to one embodiment, a display control apparatus includes a communication module, a detector and a display. The communication module is configured to communicate with an external display control apparatus. The detector is configured to detect a positional relationship of the external display control apparatus with respect to the display control apparatus. The display controller is configured to control a setting of extended display for a display screen of the external display control apparatus, based on the detected positional relationship.

### First Embodiment

For example, a notebook PC includes a display device in a main body thereof. Also, an external display device is connectable to the notebook PC. It is assumed that, when the external display device is connected to the notebook PC, a display area of the notebook PC is extended. In this case, a user may be required to manually set in advance in which direction of the upper, lower, right and left directions the display area of the display device (main screen) in the main body thereof is extended with the connected external display device. The first embodiment deals with this matter.

(1) A relative position, to the main body, where the external display device is installed is automatically detected. Also, an expansion direction of the display area is automatically set.
(2) Infrared pulse receivers are provide in three sides (for example, upper, right, and left sides) of the main screen. Also, infrared pulse transmitters are provided in three sides (for example, lower, right, and left sides) of the external display device. A position of the external display device is detected by using these receivers and transmitters.
(3) When the external display device is rotated by 90 degrees, either the receivers provided in the right or left side of the main screen detects a infrared pulse pattern transmitted from the transmitter located in a lower portion of the external display device. In this case, the upper and lower sides of the displayed screen are correctly displayed in an automatic manner.
(4) Also, when not only one external display device but also one or more other external display devices are connected to the notebook PC, positions of the one or more other external display devices can be detected similarly.

### Second Embodiment

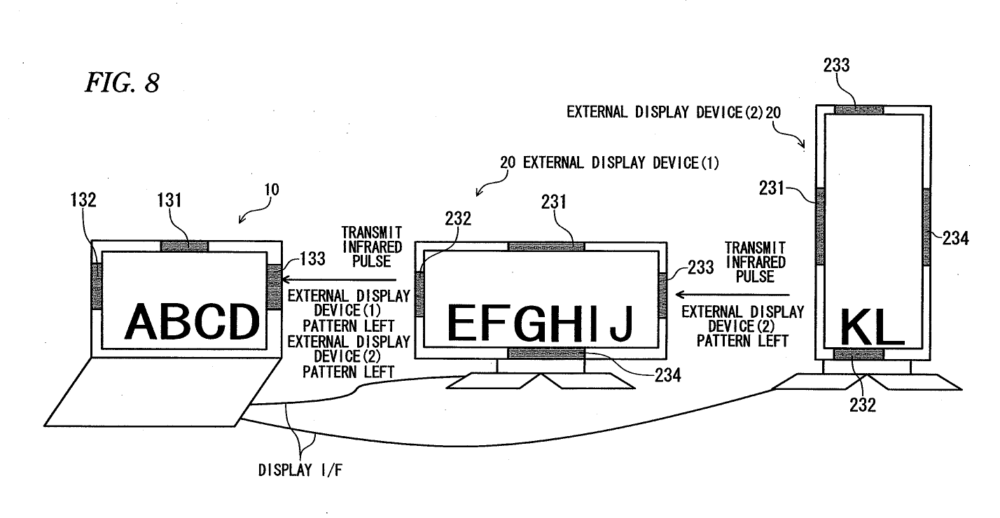

Although will be described in detail later, FIG. 8 shows an example where two external display devices are connected to a notebook PC. The notebook PC includes infrared pulse receivers (an example of a communication module) in three sides (in this example, upper, right, and left sides) of the main screen. Also, each of the external display devices includes infrared pulse transmitters/receivers (which are another example of the communication module) in the four sides thereof, respectively. In the case where the two external display devices are provided on the right side of the notebook PC when viewed from the front side of the notebook PC, the receiver on the right side of the external display device (1) receives data indicating “rightward expansion” and “270-degree rotation” and EDID (Extended Display Identification Data) via infrared pulses transmitted from the external display device (2). Also, the external display device (1) similarly transmits to the main body of the notebook PC data indicating “rightward expansion” and “0-degree rotation”, EDID, and the information of the external display device (2). The notebook PC checks EDID which are received from the respective external display devices through a display I/F and the EDID, which are received via the infrared communication against each other. A detector of the notebook PC recognizes positions, indicated by the EDID, where the respective external display devices are installed. In this example, the two external display devices are installed on the right side of the main body of the main body of the notebook PC. A controller of the notebook PC makes settings so as to extend a screen to the right side of the main screen and to rotate what is drawn in the display device (2) by 270 degrees.

Hereinafter, respective elements will be described in detail.

First, FIG. 1 is an exemplary block diagram of an apparatus (for example, a notebook PC) according to a second embodiment.

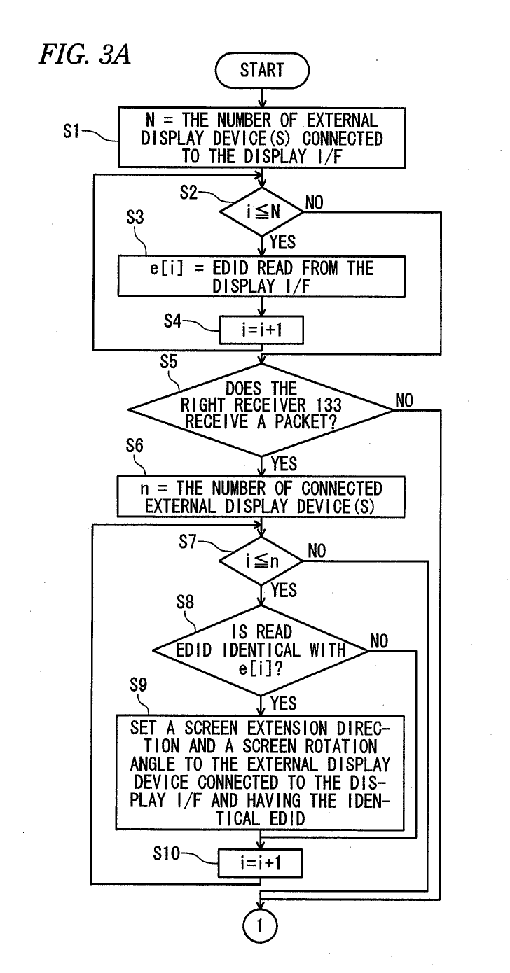

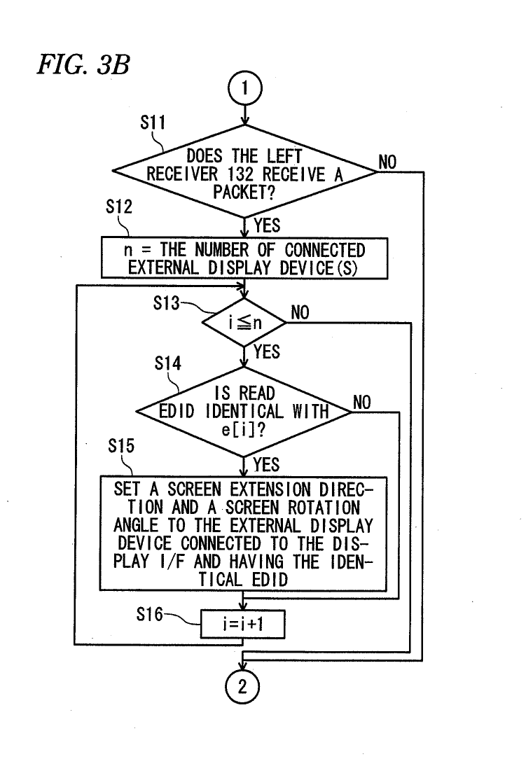

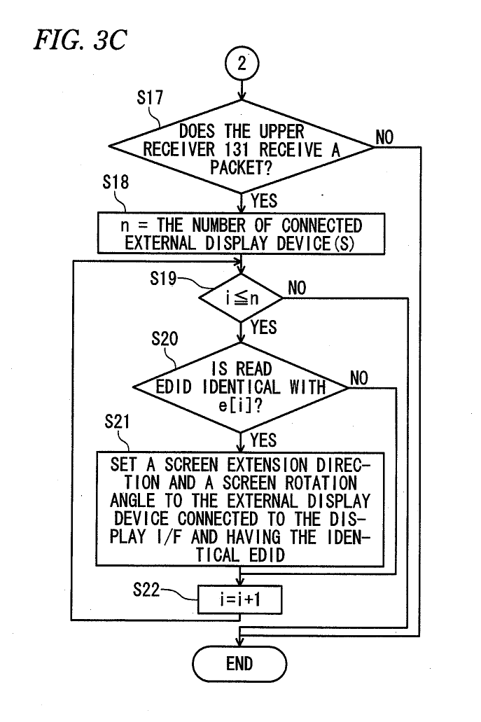

The notebook PC includes infrared pulse receivers that detect an installation position of an external display device and a status of the external display device, in three portions thereof, that is, upper, right, and left sides of the main screen. The infrared receivers are connected to an MCU (Micro Control Unit) which may serve as a main element of the detector. Received infrared packets are processed in accordance with a predetermined procedure (see description on FIGS. 3A to 3C).

The system configuration of a personal computer 10 which is the notebook PC in the second embodiment will be described in more detail.

As shown in FIG. 1, the personal computer 10 includes a CPU 111, a chip set 114, a main memory 115, a graphics processing unit (GPU) 116, the MCU 117, a BIOS-ROM which is not shown, and a hard disk drive (HDD) 121. The personal computer 10 also includes an optical disk drive (ODD), an embedded controller/keyboard controller IC (EC/KBC), a power circuit, and the like which are not shown.

The personal computer 10 further includes an upper Ir Rx 131 (upper receiver), a left Ir Rx 132 (left receiver), and a right Ir Rx 133 (right receiver) which are examples of the infrared (pulse) receiver. The personal computer 10 further includes an LCD 1 which is an example of a display device, and a display output DO that outputs a video signal in, for example, the HDMI format to the outside.

The CPU 111 is a processor which is provided to control the operation of the personal computer 10. The CPU 111 executes an operating system (OS) which is loaded from the HDD 121 into the main memory 115, drivers which control various hardwares, various application programs, and the like. The application programs include a Web browser, a music reproduction program, a mailer, a communication program, etc.

Moreover, the CPU 111 executes a system BIOS (Basic Input Output System) stored in the BIOS-ROM. The system BIOS is a program for controlling the hardwares.

The GPU 116 is a display controller which controls the LCD 1 used as a display monitor for the personal computer 10 and an external display device(s) such as a CRT(s). The external display device(s) is connected as required to an external video output terminal(s) provided in the main body of the personal computer 10, if necessary.

The GPU 116 executes a display process (graphics computation process) which draws a frame group in a video memory (VRAM; not shown), based on a drawing request transmitted from the CPU 111.

The chip set 114 incorporates an IDE (Integrated Drive Electronics) controller for controlling the HDD 121 and the optical disk drive (ODD), and a Serial ATA controller.

Although detailed description will be omitted, the embedded controller/keyboard controller IC (EC/KBC) is a one-chip microcomputer in which an embedded controller for power management, and a keyboard controller for controlling a keyboard (KB), a touch pad, general-purpose hardware buttons, and the like are integrated. Functions allocated to the general-purpose hardware buttons can be changed by settings of programs. The EC/KBC has a function of powering on/off the personal computer 10 in accordance with a user's operation of a power button switch. The control for powering on/off the personal computer 10 is executed by cooperation of the EC/KBC and the power circuit.

Although detailed description will be omitted, the power circuit receives power from a battery mounted on the main body of the personal computer 10 or from an external power source which is connected through an AC adaptor to the personal computer 10, and produces and supplies operation power for the respective elements. A power supply microcomputer is provided in the power circuit. The power supply microcomputer monitors the power supplies (charges and discharges) to the respective elements and the battery and the charge condition of the battery.

Although not shown in FIG. 1, modules (an audio controller and a speaker) which output sound, a communication module which communicates with an external apparatus, a camera module which captures an image (video), and the like are provided in the personal computer 10.

In the block diagram, the single display output is shown. If the GPU 116 which may be a main unit of a display controller supports a large number of outputs, the second embodiment is configured so that the automatic setting is enabled. The display output format is not limited so long as a module configured to acquire EDID from the external display device is provided. In the case of analog RGB, a DDC (Display Data Channel) of a sideband signal, or the like is used.

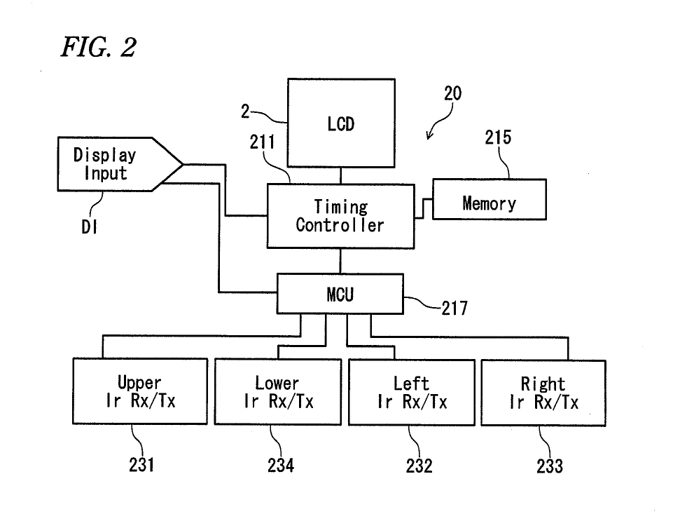

FIG. 2 is an exemplary block diagram showing an apparatus (external display device) according to the second embodiment.

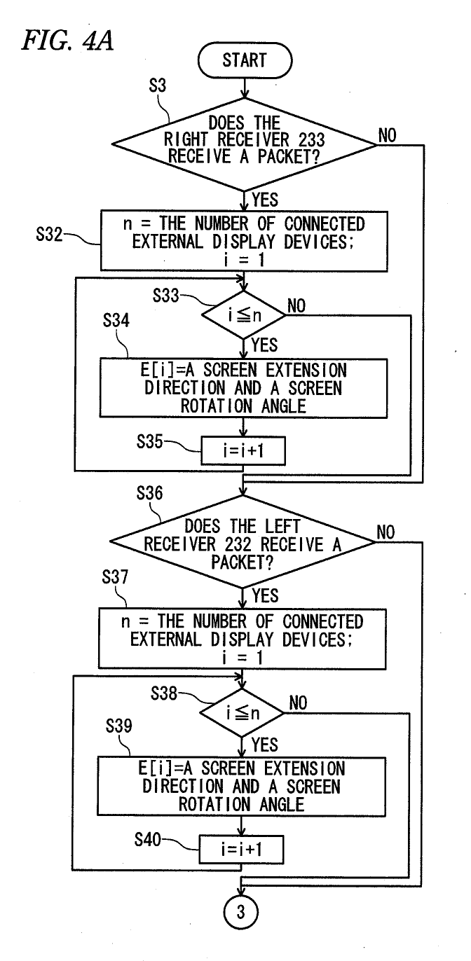

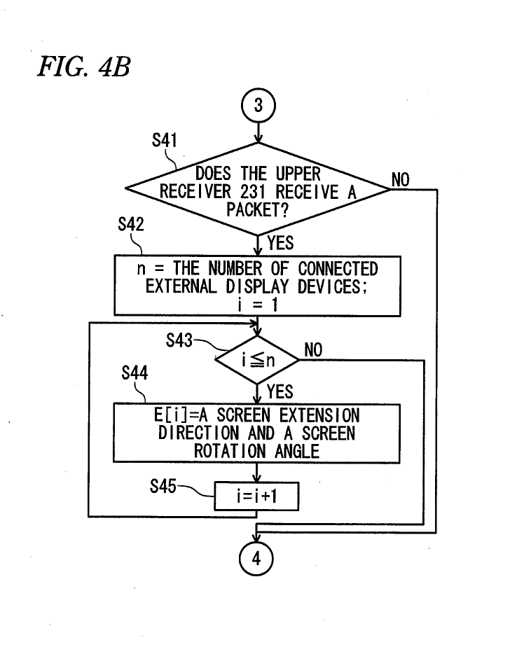

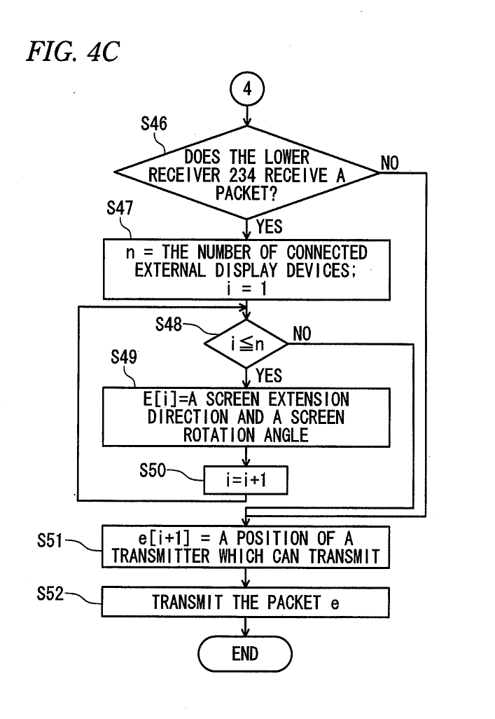

The block diagram shows an LCD monitor 20 which is an example of an external display device. The LCD monitor 20 includes an infrared transmitter(s) and an infrared receiver(s). The infrared transmitter is an example of a communication module and transmits an installation status of itself to the notebook PC 10 or another external display device. The infrared receiver is configured to acquire the installation status of another external display device. The process of transmitting the received installation status of another external display device to the main body of the notebook PC 10 in the form of a packet is performed by an MCU incorporated in the LCD monitor 20 (see description on FIGS. 4A to 4C).

Any format of the display input may be used, so long as a module configured to notify EDID is provided. The notifying module is configured in accordance with the display input format.

More specifically, the display device has a system configuration which is the partly same as that of the personal computer 10 that is the notebook PC.

As shown in FIG. 2, the display device 20 includes a timing controller 211, a main memory 215, the MCU 217, a power circuit (not shown), and the like.

The display device 20 further includes an upper Ir Tx/Rx 231 (upper receiver), a left Ir Rx/Tx 232 (left receiver), and a right Ir Rx/Tx 233 (right receiver), and a lower Ir Rx/Tx 234 (lower receiver) which are examples of the infrared receivers/transmitters. The display device 20 further includes an LCD 2 (an example of a display module), and a display input DI (an example of a part of a detector) which receives a video signal in, for example, the HDMI format from the outside.

The timing controller 211 is a processor which is provided to control the operations of the respective elements of the display device 20. The timing controller 211 executes drivers that control various hardwares, various application programs, and the like which are expanded in a main memory 215. The programs include a communication program, etc.

The timing controller 211 also serves as a display controller that controls the LCD 2 which is used as a display monitor.

FIGS. 3A to 3C are exemplary flowcharts showing a process of setting the notebook PC 10 when an external display device(s) are connected to the notebook PC 10, according to the second embodiment.

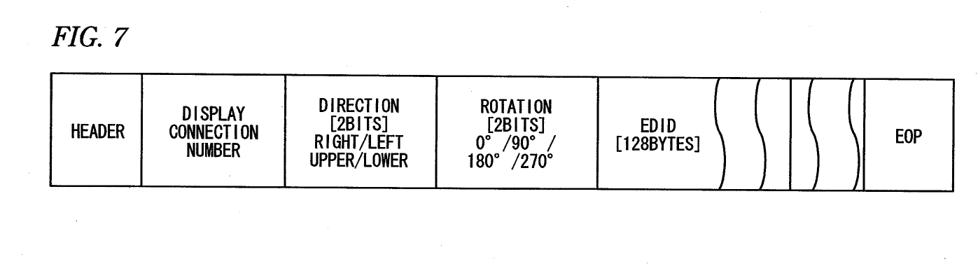

The flow shows how packets which are input from the infrared receiver are processed. The process operates as a program running on the CPU 111 of the notebook PC (FIG. 7 shows a structural example of the packet). The packet having the structure shown in FIG. 7 may be generated by the MCU 217 and stored in the memory 215 at a timing when any of the receivers 131 to 133 of the PC 10 and any of the transmitters/receivers 231 to 234 of the external display device 20 establish an infrared communication therebetween.

The CPU 111 stores EDID of an external display device connected to the display I/F of the display output DO of the notebook PC 10 in the main memory 115. Next, the CPU 111 reads packets which are received by the respective three receivers from the external display device(s) installed near the notebook PC 10, and make a display setting in accordance with the packets.

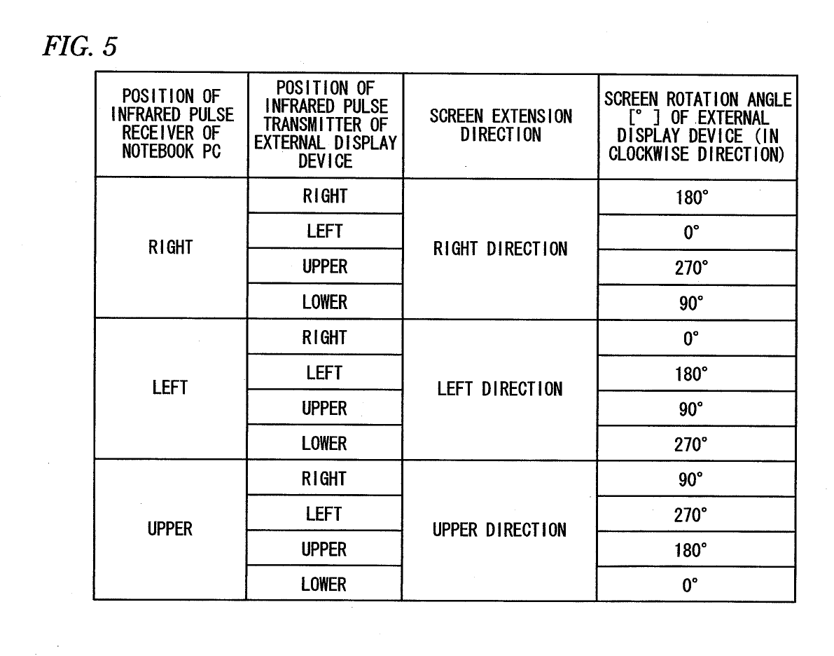

At first, the CPU 111 reads from information contained in the received packets as to how many external display devices there are beyond the external display device next to the notebook PC 10, that is, how many external devices there are which are not adjacent to the notebook PC 10 as shown in FIG. 8. Then, the CPU 111 checks the read number of the external display devices and the EEID read from the display I/F of the display output DO with each other, and configures proper settings on the external display device(s) having the corresponding EDID in accordance with parameters in an installation value table shown in FIG. 5.

The number N of connected monitors can be obtained by the GetSystemMetrics(SM_CMONITORS) function of Win32(R) API. Also, EDID are defined in Windows (registered trademark) Management Instrumentation (WMI). 128-byte RAW Data can be obtained by using WmiMonitorRawEEdidV1Block class.

Step S1: The CPU 111 obtains the number N of external display devices connected to the display I/F of the display output DO of the notebook PC 10, for example, by DDC. Also, the CPU 111 initializes a counter i (=0).
Step S2: The CPU 111 determines as to whether or not i≦N. If the determination result is positive (Yes at step S2), the process proceeds to step S3; otherwise (No at step S2), the process proceeds to step S5.
Step S3: The CPU 111 substitutes EDID which are read from the display I/F into an array e[i].
Step S4: The CPU 111 increments the counter i by one, and the process returns to step S2.
Step S5: The CPU 111 determines as to whether or not the right receiver 133 receives a packet. If the determination result is positive (Yes at step S5), the process proceeds to step S6; otherwise (No at step S5), the process proceeds to step S11.
Step S6: The CPU 111 obtains the number n of connected external display devices from the packet received by the right receiver 133. The CPU 111 also initializes the counter i (=0).
Step S7: The CPU 111 determines as to whether or not i≦n. If the determination result is positive (Yes at step S7), the process proceeds to step S8; otherwise (No at step S7), the process proceeds to step S11.
Step S8: The CPU 111 determines as to whether or not any of EDID read from the packet received by the right receiver 133 is identical with e[i]. If the determination result is positive (Yes at step S8), the process proceeds to step S9; otherwise (No at step S8), the process proceeds to step S10.
Step S9: The CPU 111 sets a screen extension direction and a screen rotation angle of the external display device, which is connected to the display of the output display OD of the notebook PC 10 and which has the EDID determined to be identical with e[i] at step S8.

For example, the CPU 111 may store the screen extension direction and the screen rotation angle of the external display device, which is connected to the display I/F of the output display OD of the notebook PC 10 and which has the EDID determined to be identical with e[i] at step S8, in the memory 115. The GPU 116 may generate video signals for the external display device, which is connected to the display I/F of the output display OD of the notebook PC 10 and which has the EDID determined to be identical with e[i] at step S8, based on the screen extension direction and the screen rotation angle, which are stored in the memory 115.

Step S10: The CPU 111 increments the counter i by one, and the process returns to step S7.
Step S11: The CPU 111 determines as to whether or not the left receiver 132 receives a packet. If the determination result is positive (Yes at step S11), the process proceeds to step S12; otherwise (No at step S11), the process proceeds to step S17.
Step S12: The CPU 111 obtains the number n of connected external display devices from the packet received by the left receiver 132. The CPU 111 also initializes the counter i (=0).
Step S13: The CPU 111 determines as to whether or not i≦n. If the determination result is positive (Yes at step S13), the process proceeds to step S14; otherwise (Not at step S13), the process proceeds to step S17.
Step S14: The CPU 111 determines as to whether or not any of EDID read from the packet received by the left receiver 132 is identical with e[i]. If the determination result is positive (Yes at step S14), the process proceeds to S15; otherwise (No at step S14), the process proceeds to step S16.
Step S15: The CPU 111 sets a screen extension direction and a screen rotation angle of the external display device, which is connected to the display I/F of the output display OD of the notebook PC 10 and which has the EDID determined to be identical with e[i] at step S14.
Step S16: The CPU 111 increments the counter i by one, and the process returns to step S13.
Step S17: The CPU 111 determines as to whether or not the upper receiver 131 receives a packet. If the determination result is positive (Yes at step S17), the process proceeds to step S18; otherwise (No at step S17), the process is ended.
Step S18: The CPU 111 obtains the number n of connected external display devices from the packet received by the upper receiver 131. The CPU 111 also initializes the counter i (=0).
Step S19: The CPU 111 determines as to whether or not i≦n. If the determination result is positive (Yes at step S19), the process proceeds to step S20; otherwise (No at step S19), the process is ended.
Step S20: The CPU 111 determines as to whether or not any of EDID read from the packet received by the upper receiver 131 is identical with e[i]. If the determination result is positive (Yes at step S20), the process proceeds to step S21; otherwise (No at step S20), the process proceeds to step S22.
Step S21: The CPU 111 sets a screen extension direction and a screen rotation angle of the external display device, which is connected to the display I/F of the display output DO of the notebook PC 1 and which has the EDID determined to be identical with e[i] at step S20.
Step S22: The CPU 111 increments the counter i by one, and the process returns to step S19.

FIGS. 4A to 4C is an exemplary flowchart showing a process of setting an external display device(s) when the external display device(s) are connected to the notebook PC 10, according to the second embodiment.

At first, when receiving a packet by at least one of the infrared receivers/transmitters 231 to 234, which are provided in the four sides of one external display device, the one external display device recognizes that another external display device is located at a position adjacent thereto. Also, the one external display device may recognize, based on the received packet, that further another external device is installed beyond said another external display device.

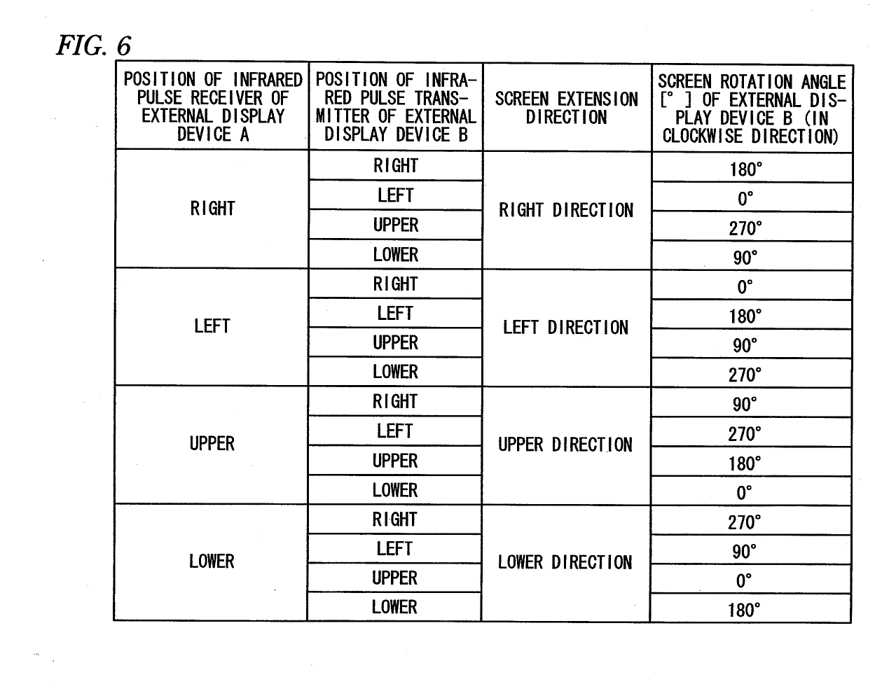

Next, the one external device constructs a packet(s) to be sent to the notebook PC 10 and/or said another external display device based on the position of the infrared receiver, which receives the packet, and a setting value table shown in FIG. 6. After the packet construction process is completed for all the receivers 231 to 234, the one external display device specifies a position of a transmitter that can perform transmission to an external display device or the notebook PC 10. Then, the one external display device adds information of the one external display device (including position information (for example, right, left, upper or lower) of the specified transmitter, a screen extension direction of the one external display device and a screen rotation angle of the one external display device) to the setting value table shown in FIG. 6 and transmits by the specified transmitter the setting value table to which the information of the one external display device is added.

Step S31: The one external display device 20 (hereinafter may be simply referred to as “the external display device 20”) determines as to whether or not the right receiver 233 thereof receives a packet. If the determination result is positive (Yes at step S31), the process proceeds to step S32; otherwise (No at step S31), the process proceeds to step S36.
Step S32: The external display device 20 obtains the number n of connected external display devices from the received packet. The external display device 20 also initializes the counter i (=1).
Step S33: The external display device 20 determines as to whether or not i≦n. If the determination result is positive (Yes at step S33), the process proceeds to step S34; otherwise (No at steps S33), the process proceeds to step S36.
Step S34: The external display device 20 sets a screen extension direction and a screen rotation angle to E[i].
Step S35: The external display device 20 increments the counter i by one, and the process returns to step S33.
Step S36: The external display device 20 determines as to whether or not the left receiver 232 thereof receives a packet. If the determination result is positive (Yes at step S36), the process proceeds to step S37; otherwise, the process proceeds to step S41.
Step S37: The external display device 20 obtains the number n of connected external display devices from the received packet. The external display device 20 also initializes the counter i (=1).
Step S38: The external display device 20 determines as to whether or not i≦n. If the determination result is positive (Yes at step S38), the process proceeds to step S39; otherwise (No at step S38) the process proceeds to step S41.
Step S39: The external display device 20 sets a screen extension direction and a screen rotation angle to E[i].
Step S40: The external display device 20 increments the counter i by one, and the process returns to step S38.
Step S41: The external display device 20 determines as to whether or not the upper receiver 231 thereof receives a packet. If the determination result is positive (Yes at step S41), the process proceeds to the step S42; otherwise (No at step S41), the process proceeds to step S46.
Step S42: The external display device 20 obtains the number n of connected external display devices from the received packet. The external display device 20 also initializes the counter i (=1).
Step S43: The external display device 20 determines as to whether or not i n. If the determination result is positive (Yes at step S43), the process proceeds to step S44); otherwise (No at step S43), the process proceeds to step S46.
Step S44: The external display device 20 sets a screen extension direction and a screen rotation angle to E[i].
Step S45: The external display device 20 increments the counter i by one, and the process returns to step S43.
Step S46: The external display device 20 determines as to whether or not the lower receiver 234 thereof receives a packet. If the determination result is positive (Yes at step S46), the process proceeds to step S47; otherwise (No at step S46), the process proceeds to step S51.
Step S47: The external display device 20 obtains the number n of connected external display devices from the received packet. The external display device 20 also initializes the counter i (=1).
Step S48: The external display device 20 determines as to whether or not i≦n. If the determination result is positive (Yes at step S48), the process proceeds to step 49; otherwise (No at step S49), the process proceeds to step S51.
Step S49: The external display device 20 sets a screen extension direction and a screen rotation angle to E[i].
Step S50: The external display device 20 increments the counter i by one, and the process returns to step S48.
Step S51: The external display device 20 adds a position of a transmitter, which can transmit to another external display device or the notebook PC 10, to a packet E as E[i+1].
Step S52: The external display device 20 transmits the packet E, and the process is ended.

FIG. 5 is an exemplary view showing a setting value table (1) of an external display device (notebook PC-external display device).

In accordance with installation positions of the notebook PC 10 and the external display device 20 and statuses of the PC 10 and the external display device 20, the table collectively shows indicates an extension direction of a screen and also indicates as to whether or not it is necessary to rotate drawn contents. The CPU 111 of the notebook PC 10 configures settings of the screen display of the external display device 20 in accordance with the table. Data corresponding to the table are used while being stored in, for example, the main memory 115 of the notebook PC 10.

FIG. 6 is an exemplary view showing a setting value table (2) of external display devices (external display device A-external display device B), according to the second embodiment.

The table of FIG. 6 collectively shows display settings in the case where external display devices are adjacent to each other. The external display devices construct packets to be transmitted, in accordance with the table. Data corresponding to the table are used while being stored in, for example, the main memories 215 of the respective external display devices.

FIG. 7 is an exemplary view showing a structural example of an infrared pulse packet which is used in the second embodiment.

FIG. 7 exemplarily shows a structural example of a packet which is transmitted and received between the notebook PC 10 and the external display device 20 or between the external display devices 20. Following the header, the packet includes (a) the number of an external display device(s) which are adjacent to an external display device which transmits the packet, and (b) a screen extension direction and a screen rotation angle which are created based on the setting value table of FIG. 6. The packet further includes EDID indicating the external display device which is to be set up (that is, indicating the external display device which transmits the packet). More correctly, the packet includes sets of information (containing the screen extension direction, the screen rotation angle, and the EEID) which are equal in number to the external display devices.

FIG. 8 is an exemplary diagram showing an example of a connection among the notebook PC 10 and two external display devices 20 according to the second embodiment.

FIG. 8 shows the example where the two external display devices 20 are connected to the notebook PC 10. The notebook PC 10 includes the infrared pulse receivers 131 to 133 on the three sides (upper, left, and right sides) of the main screen thereof. Also, each of the external display devices 20 includes the infrared pulse transmitters/receivers 231 to 234 on the four sides (upper, lower, left and right sides) thereof, respectively. Where the two external display devices 20 are installed on the right side of the notebook PC 10, the right receiver 233 of the external display device (1) 20 receives infrared pulses, from the external display device (2) 20, indicating “rightward expansion”, “270-degree rotation”, and EDID. Then, the external display device (1) 20 transmits to the main body of the notebook PC 10 “rightward expansion”, “0-degree rotation”, and EDID together with the information of the external display device (2). The notebook PC 10 checks EDID, which are received from the respective external display devices 20 via the display I/F, and the EDID, which are received by the infrared communication, with each other and recognizes installation positions of the respective external display devices 20 indicated by the EDID. In this example, the two external display devices 20 are installed on the right side of the notebook PC 10, and the notebook PC 10 configures settings so as to extend the screen to the right side of the main screen and to rotate drawing in the external display device (2) 20 by 270 degrees.

### (Modifications)

In the example shown in FIG. 8, the packet having the structure shown in FIG. 7 and transmitted from the external display device (1) 20 to the notebook PC 10 includes the display connection number (the number of connected display devices; 2 in this example), the screen extension direction (“rightward expansion” in this example) of the external display device (2) 20, the screen rotation angle (“270-degree rotation” in this example) of the external display device (2) 20, the EDID of the external display device (2) 20, the screen extension direction (“rightward expansion” in this example) of the external display device (1) 20, the screen rotation angle (“0-degree rotation” in this example) of the external display device (1) 20, and the EDID of the external display device (1) 20. The above embodiments may be modified so that each external display device generates a packet including a screen extension direction, a screen rotation angle, and EDID of each external display device itself and upon receipt of a packet including a screen extension direction, a screen rotation angle, and EDID of another external display device, each external display device allows the received packet to pass therethrough and transmits the received packet toward the notebook computer as it is.

The modification will be described in more detail below. It is assumed that the notebook computer 10 and the external display device (1) 20 have already been installed and that the external display device (2) 20 is newly installed on the right side of the external display device (1) 20. In this modification, the positional relationship between the notebook computer 10, the external display device (1) 20, and the external display device (2) 20 is the same as that shown in FIG. 8.

At a timing when any of the transmitters/receivers 231 to 234 of the external display device (1) 20 and any of the transmitters/receivers 231 to 234 of the external display device (2) 20 establish an infrared communication therebetween, the MCU 217 of the external display device (1) 20 determines a screen extension direction (“rightward expansion”) of the external display device (2) 20 and a screen rotation angle (“270-degree rotation”) of the external display device (2) 20 based on (i) the setting value table of FIG. 6 stored in the memory 215 of the external display device (1) 20 in advance and (ii) the fact that the right receiver 233 of the external display device (1) 20 receives a packet for initiation of the infrared communication transmitted from the upper transmitter 231 of the external display device (2) 20. Then, the MCU 217 of the external display device (1) 20 causes the right transmitter 233 of the external display device (1) 20 to transmit information indicating the determined screen extension direction and the determined screen rotation angle of the external display device (2) 20.

Upon receipt of the information transmitted from the external display device (1) 20, the MCU 217 of the external display device (2) 20 generates a packet including a display connection number (the number of connected external display devices), the screen extension direction of the external display device (2) 20, the screen rotation angle of the external display device (2) 20, and the EDID of the external display device (2) 20, based on the received information. It is noted that the packet generated by the external display device (2) 20 here has a similar structure to that shown in FIG. 7, but does not include the screen extension direction, the screen rotation angle, and the EDID of any external display device other than the external display device (2) 20.

Then, the MCU 217 of the external display device (2) 20 causes the upper transmitter 231 of the external display device (2) 20 to transmit the generated packet to the external display device (1) 20. Upon receipt of the packet including a screen extension direction, a screen rotation angle, and EDID of another external display device by any of the transmitters/receivers 231 to 234 of the external display device (1) 20, the MCU 217 of the external display device (1) 20 allows the received packet to pass therethrough. For example, the left transmitter 232 of the external display device (1) 20 transmits the received packet to the notebook computer 10 as it is.

Upon receipt, by any of the receivers 131 to 133, of the packet transmitted from the external display device (1) 20 and including a screen extension direction, a screen rotation angle, and EDID of another external display device than the external display device (1) 20, the CPU 111 of the notebook computer 10 sets the screen extension direction and the screen rotation angle of the other external display device (in this modification, the external display device (2) 20). In order to set the screen extension direction and the screen rotation angle of the other external display device, the CPU 111 of the notebook computer 10 may perform the process shown in FIGS. 3A to 3C.

In the case where an information apparatus to which an external display device(s) can be connected has a display device in its main body and an external display device is connected to the information apparatus, when a display area of the display device of the main body is extended, a user is generally required to manually set in which direction of the upper, lower, right and left directions of the display device of the main body the display area is to be extended by the connected external display device. However, according to the embodiments, a positional relationship between the main screen and the external display device(s) can be automatically set up.

The embodiments, particularly a notebook PC or the like, has at least the following two advantages.

(1) The above-described effect can be achieved without mounting a plurality of display I/F connectors on the main body, for external display devices.
(2) The automatic setting can be realized irrespective of the angles and installation positions of the main screen of the main body of the notebook PC and the external display device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control apparatus comprising:
a communication module configured to communicate with an external display control apparatus;
a detector configured to detect a positional relationship of the external display control apparatus with respect to the display control apparatus; and
a display controller configured to control a setting of extended display for a display screen of the external display control apparatus, based on the detected positional relationship.

2. The display control apparatus according to claim 1, wherein
the communication module is configured to perform the communication with directionality, and
the display controller is configured to control the setting based on the directionality.

3. The display control apparatus according to claim 1, wherein the display controller is configured to control the setting Extended Display Identification Data.

4. The display control apparatus according to claim 1, wherein the display controller is configured to control settings of extended display for display screens of a plurality of external display control apparatuses.

5. A display control apparatus comprising:
a communication module configured to communicate with an external display control apparatus;
a detector configured to detect a setting of extended display for a display screen from the external display control apparatus in relation to the display control apparatus; and
a display controller configured to control the display screen based on the detected setting.

6. The display control apparatus according to claim 5, wherein
the communication module is configured to perform the communication with directionality, and
the setting is based on the directionality.

7. The display control apparatus according to claim 5, wherein the setting is based on Extended Display Identification Data.

8. A display control method comprising:
communicating with an external display control apparatus;
detecting a positional relationship of the external display control apparatus with respect to a local display control apparatus, and
controlling a setting of extended display for a display screen of the external display control apparatus, based on the detected positional relationship.
